(19) United States
(12) Patent Application Publication
(10) Pub. No.: US 2017/0335145 A1
(43) Pub. Date: Nov. 23, 2017

(54) DOUBLE-SIDED PRESSURE-SENSITIVE ADHESIVE TAPE

(71) Applicants: NITTO DENKO MATERIALS (MALAYSIA) SDN. BHD., Shah Alam (MY); NITTO DENKO CORPORATION, Osaka (JP)

(72) Inventors: NURUL JANNA BINTI ABDULLAH, Shah Alam (MY); NOR FARAH AIN BINTI MOHAMAD NAZRI, Shah Alam (MY); KAZUYUKI KIUCHI, Osaka (JP); TSUNAKI KITAHARA, Osaka (JP)

(73) Assignees: NITTO DENKO MATERIALS (MALAYSIA) SDN. BHD.; NITTO DENKO CORPORATION

(21) Appl. No.: 15/594,294

(22) Filed: May 12, 2017

(30) Foreign Application Priority Data
May 17, 2016 (MY) 2016000919
Apr. 14, 2017 (MY) 2017701334

(51) Int. Cl. C09J 7/02; C08F 220/18; C09J 133/10; C09J 7/04; C09J 133/08; B32B 27/30; B32B 7/12

(52) U.S. Cl. CPC C09J 7/0246; C09J 7/0217; B32B 27/308; C08F 220/18; B32B 7/12; C09J 7/0292; C09J 7/045; C09J 133/08; C09J 133/10; B32B 2309/105; B32B 2405/00; B32B 2307/54; C08F 2220/1808; C08F 2220/1825; C09J 2400/163; C09J 2400/283; C09J 2433/00

(57) ABSTRACT

A double-sided pressure-sensitive adhesive tape includes a first pressure-sensitive adhesive layer, a base material, and a second pressure-sensitive adhesive layer in the stated order, in which the second pressure-sensitive adhesive layer has a pressure-sensitive adhesive strength with respect to a SUS304 steel plate, which is larger than a pressure-sensitive adhesive strength of the first pressure-sensitive adhesive layer with respect to the SUS304 steel plate, in which the pressure-sensitive adhesive strength of the first pressure-sensitive adhesive layer with respect to the SUS304 steel plate is from 0.5 N/20 mm to 5 N/20 mm, and in which the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate have a difference of from 3 N/20 mm to 20 N/20 mm.

### CROSS-REFERENCE TO RELATED APPLICATIONS

This application is based upon and claims the benefit of priority to Malaysian Patent Application No. PI 2016000919, filed on May 17, 2016, and Malaysian Patent Application No. PI 2017701334, filed on Apr. 14, 2017. The entire contents of both applications are incorporated herein by reference.

### BACKGROUND

### Technical Field

The present invention relates to a double-sided pressure-sensitive adhesive tape.

### Background Art

A double-sided pressure-sensitive adhesive tape including a pressure-sensitive adhesive layer on each surface of a base material has been widely used for various industrial applications, and the like (JP 07-185053 A).

In general, in the double-sided pressure-sensitive adhesive tape, a release liner is formed in advance on the surface of each pressure-sensitive adhesive layer on both surfaces of the base material. When the double-sided pressure-sensitive adhesive tape is used, the release liner on one surface is peeled off, and an exposed first pressure-sensitive adhesive layer is bonded to an adherend. Then, the release liner on the other surface is peeled off, and another adherend is bonded to an exposed second pressure-sensitive adhesive layer.

However, in the related-art double-sided pressure-sensitive adhesive tape, in the case where the release liner on one surface is peeled off, and the exposed first pressure-sensitive adhesive layer is bonded to an adherend having a polar surface, such as glass or SUS, and then, the release liner on the other surface is peeled off, and an adherend having a low polar surface, such as a polyethylene sheet, is bonded to the exposed second pressure-sensitive adhesive layer, when a laminate bonded to the adherend having a polar surface (laminate of the double-sided pressure-sensitive adhesive tape and the adherend having a low polar surface) is attempted to be re-peeled in an integrated manner from the adherend having a polar surface, there arise a problem in that an adhesive residue is caused on the surface of the adherend having a polar surface, and a problem in that the second pressure-sensitive adhesive layer and the adherend having a low polar surface are peeled from each other at an interface.

### BRIEF SUMMARY

It is an object of the present invention to provide a double-sided pressure-sensitive adhesive tape to be used for re-peeling an adherend having a low polar surface from an adherend having a polar surface after bonding the adherend having a low polar surface to the adherend having a polar surface, in which a laminate of the double-sided pressure-sensitive adhesive tape and the adherend having a low polar surface can be easily peeled in an integrated manner from the adherend having a polar surface, and an adhesive residue on the surface of the adherend having a polar surface can be suppressed.

A double-sided pressure-sensitive adhesive tape of the present invention includes a first pressure-sensitive adhesive layer, a base material, and a second pressure-sensitive adhesive layer in the stated order,

in which the second pressure-sensitive adhesive layer has a pressure-sensitive adhesive strength with respect to a SUS304 steel plate, which is larger than a pressure-sensitive adhesive strength of the first pressure-sensitive adhesive layer with respect to the SUS304 steel plate,

in which the pressure-sensitive adhesive strength of the first pressure-sensitive adhesive layer with respect to the SUS304 steel plate is from 0.5 N/20 mm to 5 N/20 mm, and

in which the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate have a difference of from 3 N/20 mm to 20 N/20 mm.

In one embodiment, the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate have a difference of from 4 N/20 mm to 20 N/20 mm.

In one embodiment, the second pressure-sensitive adhesive layer has a pressure-sensitive adhesive strength with respect to polyethylene of from 3 N/20 mm to 15 N/20 mm.

In one embodiment, the double-sided pressure-sensitive adhesive tape of the present invention has an elongation ratio of 2% or more.

In one embodiment, the double-sided pressure-sensitive adhesive tape of the present invention has a tensile strength of 20 N/20 mm or more.

In one embodiment, the double-sided pressure-sensitive adhesive tape of the present invention has a tear strength of 40 N/20 mm or more.

In one embodiment, the base material includes a paper material.

In one embodiment, the first pressure-sensitive adhesive layer is formed of a first pressure-sensitive adhesive composition containing a first base polymer.

In one embodiment, the first adhesive composition has a gel fraction of 50% or more.

In one embodiment, the first base polymer includes a first acrylic polymer.

In one embodiment, the first acrylic polymer contains a monomer unit, 70 wt % or more of the monomer unit being derived from 2-ethylhexyl acrylate.

In one embodiment, the second pressure-sensitive adhesive layer is formed of a second pressure-sensitive adhesive composition containing a second base polymer.

In one embodiment, the second adhesive composition has a gel fraction of less than 70%.

In one embodiment, the second base polymer includes a second acrylic polymer.

The present invention discloses two of the preferred embodiments, namely the first embodiment and the second embodiment whereby both embodiments comprises the same first pressure-sensitive adhesive layer, base material, and release liner, but possess a different second pressure-sensitive adhesive layer. In the first embodiment, the second pressure-sensitive adhesive layer is derived from an aqueous-based adhesive. In the second embodiment, the second pressure-sensitive adhesive layer is derived from an organic solvent-based adhesive. The difference in second pressure-sensitive adhesive layer results in a change of adhesion to high polarity adherent, elongation of tape, tensile strength of tape, and edge tear strength of tape.

In the first and second embodiments, the second acrylic polymer includes a monomer unit, wherein 50 wt % or more of the monomer unit is derived from alkyl (meth)acrylate.

In one embodiment, the base material has a thickness of from 10 μm to 100 μm.

In one embodiment, the thickness of the base material is from 30 μm to 100 μm.

In one embodiment, the first pressure-sensitive adhesive layer has a thickness of from 5 μm to 50 μm.

In one embodiment, the thickness of the first pressure-sensitive adhesive layer is from 10 μm to 40 μm.

In one embodiment, the second pressure-sensitive adhesive layer has a thickness of from 10 μm to 100 μm.

In one embodiment, the thickness of the second pressure-sensitive adhesive layer is from 20 μm to 60 μm.

According to the present invention, it is possible to provide the double-sided pressure-sensitive adhesive tape to be used for re-peeling the adherend having the low polar surface from the adherend having the polar surface after bonding the adherend having the low polar surface to the adherend having the polar surface, in which the laminate of the double-sided pressure-sensitive adhesive tape and the adherend having the low polar surface can be easily peeled in the integrated manner from the adherend having the polar surface, and the adhesive residue on the surface of the adherend having the polar surface can be suppressed.

### BRIEF DESCRIPTION OF THE DRAWINGS

FIG. 1 is a schematic sectional view of a double-sided pressure-sensitive adhesive tape according to one embodiment of the present invention.

FIG. 2 is a schematic sectional view of a double-sided pressure-sensitive adhesive tape according to another embodiment of the present invention.

FIG. 3 is a plan view of a double-sided pressure-sensitive adhesive tape according to one embodiment of the present invention, in which a second pressure-sensitive adhesive layer is formed on a base material.

FIG. 4 is a plan view of a double-sided pressure-sensitive adhesive tape according to another embodiment of the present invention, in which a second pressure-sensitive adhesive layer is formed on a base material.

### DETAILED DESCRIPTION

The term “(meth)acrylic” as used herein refers to “acrylic and/or methacrylic”, and the term “(meth)acrylate” as used herein refers to “acrylate and/or methacrylate”. Further, the term “weight” as used herein may be read as “mass”, which is generally used as an SI unit expressing weight.

In the case of the expression “monomer unit (A) derived from (a)” as used herein, the monomer unit (A) is a structural unit which is formed when an unsaturated double bond of the monomer (a) is cleaved by polymerization. It should be noted that the structural unit which is formed when an unsaturated double bond is cleaved by polymerization refers to a structural unit of “-RpRqC—CRrRs-” which is formed when an unsaturated double bond “C═C” of a structure of “RpRqC═CRrRs” (Rp, Rq, Rr, and Rs each represent any suitable group bonded to a carbon atom through a single bond) is cleaved by polymerization.

In this specification, the content ratio of a monomer unit in a polymer can be known by, for example, various structural analyses (such as NMR) of the polymer. Further, even if various structural analyses described above are not conducted, the content ratio of a monomer unit derived from various monomers calculated based on a usage amount of the various monomers to be used for producing a polymer may be defined as the content ratio of the monomer unit in the polymer. That is, the content ratio of a monomer (m) in all the monomer components to be used for producing a polymer may be used as the content ratio of a monomer unit derived from the monomer (m) in the polymer.

A double-sided pressure-sensitive adhesive tape of the present invention is a double-sided pressure-sensitive adhesive tape that includes a first pressure-sensitive adhesive layer, a base material, and a second pressure-sensitive adhesive layer in the stated order. Any suitable configuration may be employed for the double-sided pressure-sensitive adhesive tape of the present invention within such a range as not to impair the effects of the present invention, as long as the double-sided pressure-sensitive adhesive tape includes the first pressure-sensitive adhesive layer, the base material, and the second pressure-sensitive adhesive layer in the stated order.

FIG. 1 is a schematic sectional view of a double-sided pressure-sensitive adhesive tape according to one embodiment of the present invention. In FIG. 1, a double-sided pressure-sensitive adhesive tape 100 includes a base material 30, a first pressure-sensitive adhesive layer 10 formed on one surface of the base material 30, and a second pressure-sensitive adhesive layer 20 formed on the other surface of the base material 30. Any other suitable layer, such as a primer layer, may be formed between the base material 30 and the first pressure-sensitive adhesive layer 10 and between the base material 30 and the second pressure-sensitive adhesive layer 20 within such a range as not to impair the effects of the present invention. The base material 30 may be formed of one layer or two or more layers.

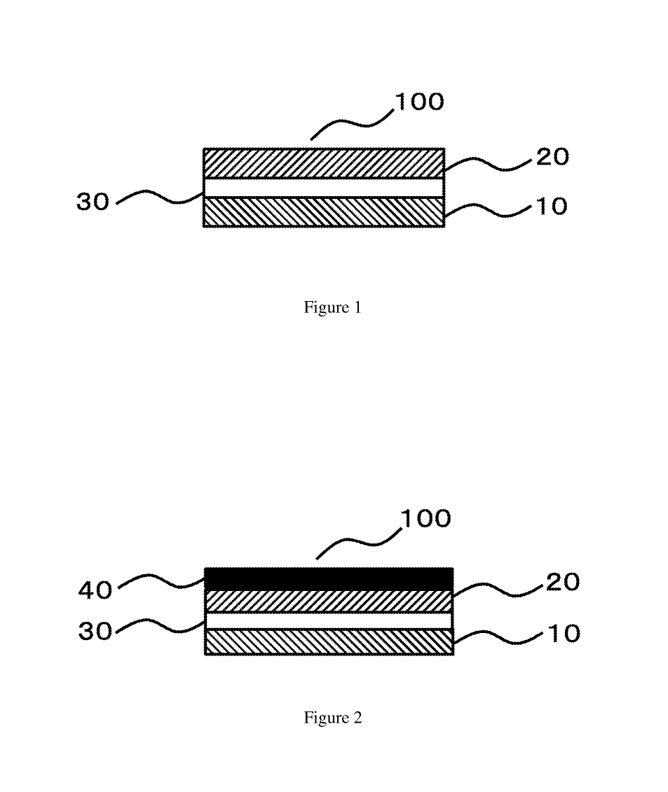

FIG. 2 is a schematic sectional view of a double-sided pressure-sensitive adhesive tape according to another embodiment of the present invention. In FIG. 2, the double-sided pressure-sensitive adhesive tape 100 includes the base material 30, the first pressure-sensitive adhesive layer 10 formed on one surface of the base material 30, the second pressure-sensitive adhesive layer 20 formed on the other surface of the base material 30, and a release liner 40 formed on a surface of the second pressure-sensitive adhesive layer 20 on an opposite side to the base material 30. Any other suitable layer, such as a primer layer, may be formed between the base material 30 and the first pressure-sensitive adhesive layer 10 and between the base material 30 and the second pressure-sensitive adhesive layer 20 within such a range as not to impair the effects of the present invention. The base material 30 may be formed of one layer or two or more layers.

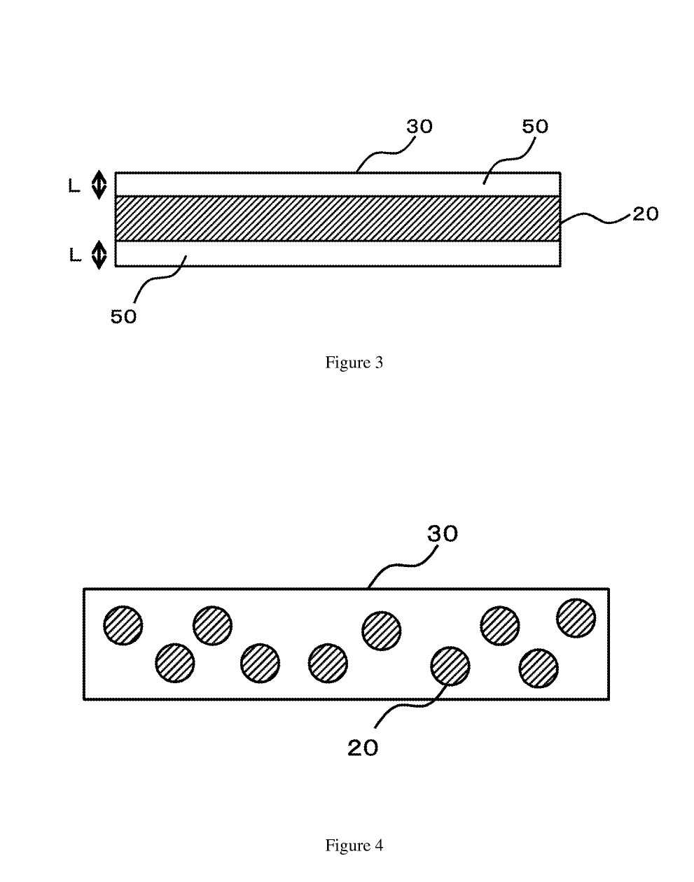

In the double-sided pressure-sensitive adhesive tape of the present invention, the first pressure-sensitive adhesive layer and the second pressure-sensitive adhesive layer may be formed over the entire surfaces of the base material, or the first pressure-sensitive adhesive layer and the second pressure-sensitive adhesive layer may be formed on parts of the surfaces of the base material. FIG. 3 is a plan view of a double-sided pressure-sensitive adhesive tape according to one embodiment of the present invention in which the second pressure-sensitive adhesive layer 20 is formed on the base material 30. In FIG. 3, portions (dry edges) 50 in each of which the second pressure-sensitive adhesive layer 20 is not formed are present on the base material 30. The portion in which the pressure-sensitive adhesive layer is not formed is generally called a dry edge. Through formation of the dry edge in an end portion of the base material, the adhesion of dirt and foreign matters caused by a pressure-sensitive adhesive to the end portion can be suppressed. In FIG. 3, a width L of each of the dry edges 50 may be set appropriately depending on the purpose. Typically, the width of each of the dry edges 50 is, for example, preferably from 1 mm to 10 mm, more preferably from 2 mm to 9 mm, still more preferably from 3 mm to 8 mm, particularly preferably from 4 mm to 7 mm.

In the case where the pressure-sensitive adhesive layer side exhibiting a particularly strong pressure-sensitive adhesive property is formed into a dry edge, when the double-sided pressure-sensitive adhesive tape is cut into a small roll from a jumbo (or standard-length) roll, the pressure-sensitive adhesive does not stick to the side surface of a cutting blade, and stickiness on the tape side surface is eliminated, and hence blocking in packaging (trouble in which two tape side surfaces are subjected to autohesion and cannot be separated from each other) can be avoided, with the result that a slip sheet in the related art is not required. Further, the life duration of the cutting blade can be prolonged, and hence the dry edge greatly contributes to the improvement of product quality and productivity. Thus, when such dry-edge type tape is used particularly outdoors or at a place filled with grit and dust, small stones and foreign matters are not liable to adhere to the tape side surface, and hence satisfactory workability is also provided. Such dry-edge type tape may be preferably used for a double-sided tape for (temporarily) fixing wood pieces in DIY, a double-sided tape for (temporary) fixing, which is used for positioning and stacking stone materials such as blocks, a double-sided tape for fixing a residential moisture-permeable waterproof sheet, and the like. As a double-sided pressure-sensitive adhesive tape according to another embodiment of the present invention in which the first pressure-sensitive adhesive layer and the second pressure-sensitive adhesive layer are formed on parts of the surfaces of the base material, for example, there is given an embodiment in which the second pressure-sensitive adhesive layer is formed in a stripe shape, a dot shape, a lattice shape, or the like on the base material. FIG. 4 is a plan view of a double-sided pressure-sensitive adhesive tape according to another embodiment of the present invention in which the second pressure-sensitive adhesive layer 20 is formed on the base material 30. In FIG. 4, the second pressure-sensitive adhesive layer 20 is formed in a dot shape on the base material 30.

In the double-sided pressure-sensitive adhesive tape of the present invention, the pressure-sensitive adhesive strength of the second pressure-sensitive adhesive layer with respect to a SUS304 steel plate is larger than that of the first pressure-sensitive adhesive layer with respect to the SUS304 steel plate. When the pressure-sensitive adhesive strength of the second pressure-sensitive adhesive layer with respect to the SUS304 steel plate is larger than that of the first pressure-sensitive adhesive layer with respect to the SUS304 steel plate, the following can be achieved in combination with the other features of the present invention. Specifically, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be easily peeled in an integrated manner from the adherend having a polar surface, and an adhesive residue on the surface of the adherend having a polar surface can be suppressed.

The present invention discloses two of the preferred embodiments, namely the first embodiment and the second embodiment where both embodiments comprise the same first pressure-sensitive adhesive layer, base material, and release liner, but possess a different second pressure-sensitive adhesive layer. In the first embodiment, the second pressure-sensitive adhesive layer is derived from an aqueous-based adhesive. In the second embodiment, the second pressure-sensitive adhesive layer is derived from an organic solvent-based adhesive. The difference in second pressure-sensitive adhesive layer results in a change of adhesion to high polarity adherent, elongation of tape, tensile strength of tape, and edge tear strength of tape.

A method of measuring the pressure-sensitive adhesive strength of the first pressure-sensitive adhesive layer with respect to the SUS304 steel plate and the pressure-sensitive adhesive strength of the second pressure-sensitive adhesive layer with respect to the SUS304 steel plate is described later in detail.

In the double-sided pressure-sensitive adhesive tape of the present invention, the pressure-sensitive adhesive strength of the first pressure-sensitive adhesive layer with respect to the SUS304 steel plate is from 0.5 N/20 mm to 5 N/20 mm, preferably from 1.0 N/20 mm to 5.0 N/20 mm, more preferably from 1.5 N/20 mm to 5.0 N/20 mm, still more preferably from 2.0 N/20 mm to 5.0 N/20 mm, particularly preferably from 2.5 N/20 mm to 5.0 N/20 mm. When the pressure-sensitive adhesive strength of the first pressure-sensitive adhesive layer with respect to the SUS304 steel plate falls within the above-mentioned range, the following can be achieved in combination with the other features of the present invention. Specifically, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be easily peeled in an integrated manner from the adherend having a polar surface, and an adhesive residue on the surface of the adherend having a polar surface can be suppressed.

In the double-sided pressure-sensitive adhesive tape of the present invention, a difference between the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate is from 3 N/20 mm to 20 N/20 mm, preferably from 4 N/20 mm to 20 N/20 mm, more preferably from 5 N/20 mm to 20 N/20 mm, still more preferably from 6 N/20 mm to 20 N/20 mm, particularly preferably from 8 N/20 mm to 20 N/20 mm. When the difference between the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate falls within the above-mentioned range, the following can be achieved in combination with the other features of the present invention. Specifically, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be easily peeled in an integrated manner from the adherend having a polar surface, and an adhesive residue on the surface of the adherend having a polar surface can be suppressed.

In the double-sided pressure-sensitive adhesive tape of the present invention, the pressure-sensitive adhesive strength of the second pressure-sensitive adhesive layer with respect to polyethylene is preferably from 1 N/20 mm to 15 N/20 mm, more preferably from 2 N/20 mm to 12 N/20 mm, still more preferably from 3 N/20 mm to 12 N/20 mm. In the case where the pressure-sensitive adhesive strength of the second pressure-sensitive adhesive layer with respect to polyethylene falls within the above-mentioned range, the following can be achieved, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more.

A method of measuring the pressure-sensitive adhesive strength of the second pressure-sensitive adhesive layer with respect to polyethylene is described later in detail.

The elongation ratio of the double-sided pressure-sensitive adhesive tape of the present invention is preferably 2% or more, more preferably from 2% to 30%, still more preferably from 2% to 20%, particularly preferably from 2% to 15%. When the elongation ratio of the double-sided pressure-sensitive adhesive tape of the present invention falls within the above-mentioned range, the following can be achieved, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more.

A method of measuring the elongation ratio of the double-sided pressure-sensitive adhesive tape of the present invention is described later in detail.

The tensile strength of the double-sided pressure-sensitive adhesive tape of the present invention is preferably 20 N/20 mm or more, more preferably from 20 N/20 mm to 140 N/20 mm, still more preferably from 80 N/20 mm to 140 N/20 mm, particularly preferably from 100 N/20 mm to 140 N/20 mm. In the first embodiment, the tensile strength of the double-sided pressure sensitive adhesive tape is preferred to range from 20 N/20 mm to 100 N/20 mm, still more preferably from 20 N/20 mm to 80 N/20 mm, particularly preferably from 20 N/20 mm to 70 N/20 mm. On the other hand, in the second embodiment, the tensile strength of the double-sided pressure sensitive adhesive tape is 20 N/20 mm to 140 N/20 mm, still more preferably from 80 N/20 mm to 140 N/20 mm, particularly preferably from 100 N/20 mm to 140 N/20 mm. When the tensile strength of the double-sided pressure-sensitive adhesive tape of the present invention falls within the above-mentioned range, the following can be achieved, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more.

A method of measuring the tensile strength of the double-sided pressure-sensitive adhesive tape of the present invention is described later in detail.

The tear strength of the double-sided pressure-sensitive adhesive tape of the present invention is preferably 40 N/20 mm or more, more preferably from 40 N/20 mm to 100 N/20 mm, still more preferably from 40 N/20 mm to 90 N/20 mm, particularly preferably from 40 N/20 mm to 80 N/20 mm. For the first embodiment, the preferred tear strength ranges from 50 N/20 mm to 90 N/20 mm, whereas for the second embodiment, the preferred tear strength ranges from 70 N/20 mm to 90 N/20 mm. When the tear strength of the double-sided pressure-sensitive adhesive tape of the present invention falls within the above-mentioned range, the following can be achieved, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more. It should be noted the upper limit value of the tear strength refers to a critical numerical value required for satisfactory workability, such as good tearability.

A method of measuring the tear strength of the double-sided pressure-sensitive adhesive tape of the present invention is described later in detail.

In the double-sided pressure-sensitive adhesive tape of the present invention, the thickness of the base material is preferably from 10 μm to 100 μm, more preferably from 20 μm to 100 μm, still more preferably from 25 μm to 100 μm, particularly preferably from 30 μm to 100 μm. When the thickness of the base material falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

In the double-sided pressure-sensitive adhesive tape of the present invention, the thickness of the first pressure-sensitive adhesive layer is preferably from 5 μm to 50 μm, more preferably from 7 μm to 45 μm, still more preferably from 9 μm to 43 μm, particularly preferably from 10 μm to 40 μm. When the thickness of the first pressure-sensitive adhesive layer falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

In the double-sided pressure-sensitive adhesive tape of the present invention, the thickness of the second pressure-sensitive adhesive layer is preferably from 10 μm to 100 μm, more preferably from 15 μm to 80 μm, still more preferably from 18 μm to 70 μm, particularly preferably from 20 μm to 60 μm. When the thickness of the second pressure-sensitive adhesive layer falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

The total thickness of the double-sided pressure-sensitive adhesive tape of the present invention is preferably from 80 p m to 250 μm, more preferably from 90 μm to 210 μm, still more preferably from 100 μm to 180 μm, particularly preferably from 110 μm to 150 μm. When the total thickness of the double-sided pressure-sensitive adhesive tape of the present invention falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more. It should be noted that, in the present invention, when a release liner is used, the thickness of the release liner is not included in the total thickness of the double-sided pressure-sensitive adhesive tape.

### <Base Material>

As the base material, any suitable base material may be employed within such a range as not to impair the effects of the present invention. Examples of such base material include a paper material and a plastic film. From the viewpoint that the effects of the present invention can be further exhibited, the paper material (porous tissue paper material) is preferred as the base material. As the paper material, for example, there are given paper materials formed of fibrous substances, such as craft paper, crepe paper, and Japanese paper (such as beaten wood pulp or Japanese paper obtained by mixing one or more kinds of synthetic short fibers with beaten wood pulp). Of those paper materials, Japanese paper is preferred. When the paper material is employed as the base material, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more. As the basis weight of the porous tissue paper material, any suitable basis weight may be employed within such a range as not to impair the effects of the present invention. Such basis weight is preferably from 15 g/m² to 80 g/m², more preferably from 25 g/m² to 55 g/m². As the thickness of the porous tissue paper material, any suitable thickness may be employed within such a range as not to impair the effects of the present invention. Such thickness is preferably from 40 μm to 120 μm , more preferably from 50 μm to 90 μm . It should be noted that the base material may have an impregnating agent applied thereto as necessary.

### <First Pressure-Sensitive Adhesive Layer>

As a pressure-sensitive adhesive forming the first pressure-sensitive adhesive layer, any suitable pressure-sensitive adhesive may be employed within such a range as not to impair the effects of the present invention. The pressure-sensitive adhesive forming the first pressure-sensitive adhesive layer is preferably formed of a first pressure-sensitive adhesive composition containing a first base polymer.

From the viewpoint that the effects of the present invention can be further exhibited, the content ratio of the first base polymer in the first pressure-sensitive adhesive composition is preferably from 90.0 wt % to 100 wt %, more preferably from 95.0 wt % to 99.99 wt %, still more preferably from 97.0 wt % to 99.97 wt %, particularly preferably from 99.0 wt % to 99.95 wt %. When the content ratio of the first base polymer in the first pressure-sensitive adhesive composition falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

From the viewpoint that the effects of the present invention can be further exhibited, the gel fraction of the first adhesive composition is preferably 50% or more, more preferably from 50% to 100%, still more preferably from 55% to 90%, particularly preferably from 60% to 80%. When the gel fraction of the first adhesive composition falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

As the first base polymer, any suitable polymer may be employed within such a range as not to impair the effects of the present invention. Examples of such polymer include an acrylic polymer, an olefin-based polymer, a styrene-based polymer, a urethane-based polymer, and a silicone-based polymer.

When the first base polymer is a first acrylic polymer, the first acrylic polymer preferably contains a monomer unit derived from a (meth)acrylic acid alkyl ester having 2 to 14 carbon atoms in an alkyl group. The alkyl group of the (meth)acrylic acid alkyl ester having 2 to 14 carbon atoms in the alkyl group may be a straight chain or a branched chain. Examples of the (meth)acrylic acid alkyl ester having 2 to 14 carbon atoms in the alkyl group include ethyl (meth)acrylate, n-propyl (meth)acrylate, n-butyl (meth)acrylate, t-butyl (meth)acrylate, 2-ethylhexyl (meth)acrylate, isooctyl (meth)acrylate, and isononyl (meth)acrylate. Of those, n-butyl acrylate and 2-ethylhexyl acrylate are preferred from the viewpoint that the effects of the present invention can be further exhibited.

When the first base polymer is the first acrylic polymer, 70 wt % or more of a monomer unit forming the first acrylic polymer is preferably derived from 2-ethylhexyl acrylate. The above-mentioned ratio is preferably from 70 wt % to 99 wt %, more preferably from 75 wt % to 97 wt %, still more preferably from 80 wt % to 95 wt %, particularly preferably from 85 wt % to 95 wt %. When the first acrylic polymer has such composition, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more.

When the first base polymer is the first acrylic polymer, the first acrylic polymer preferably contains a monomer unit derived from a carboxyl group-containing unsaturated monomer. As the carboxyl group-containing unsaturated monomer, for example, there are given (meth)acrylic acid, itaconic acid, fumaric acid, and maleic acid. Of those, (meth)acrylic acid is preferred from the viewpoint that the effects of the present invention can be further exhibited.

When the first base polymer is the first acrylic polymer, and when the first acrylic polymer contains a monomer unit derived from a (meth)acrylic acid alkyl ester having 2 to 14 carbon atoms in an alkyl group and a monomer unit derived from a carboxyl group-containing unsaturated monomer, from the viewpoint that the effects of the present invention can be further exhibited, the ratio between the monomer unit derived from a (meth)acrylic acid alkyl ester having 2 to 14 carbon atoms in an alkyl group and the monomer unit derived from a carboxyl group-containing unsaturated monomer is as follows. When the content of the monomer unit derived from a (meth)acrylic acid alkyl ester having 2 to 14 carbon atoms in an alkyl group is defined as 100 parts by weight, the content of the monomer unit derived from a carboxyl group-containing unsaturated monomer is preferably from 0.1 part by weight to 10 parts by weight, more preferably from 0.5 part by weight to 8 parts by weight, still more preferably from 1 part by weight to 6 parts by weight, particularly preferably from 1.5 parts by weight to 5 parts by weight.

When the first base polymer is the first acrylic polymer, the first acrylic polymer may contain a monomer unit derived from any other suitable monomer within such a range as not to impair the effects of the present invention. Examples of such other monomer include: hydroxyl group-containing monomers, such as 2-hydroxyethyl (meth)acrylate, 2-hydroxypropyl (meth)acrylate, and hydroxyhexyl (meth)acrylate; nitrogen-containing (meth)acrylates, such as (meth)acrylamide and acryloylmorpholine; methyl (meth)acrylate; alkyl (meth)acrylates each having 15 or more carbon atoms in an alkyl group; vinyl acetate; (meth)acrylonitrile; styrene; vinylidene chloride; and vinyl propionate.

As the weight average molecular weight (Mw) of the first base polymer (in terms of polystyrene) measured by gel permeation chromatography (GPC), any suitable weight average molecular weight (Mw) may be employed within such a range as not to impair the effects of the present invention. From the viewpoint that the effects of the present invention can be further exhibited, the weight average molecular weight (Mw) is preferably from 10,000 to 1,000,000, more preferably from 50,000 to 900,000, still more preferably from 80,000 to 700,000, particularly preferably from 100,000 to 500,000.

The first base polymer can be produced by various known methods, and for example, there are given radial polymerization methods, such as a bulk polymerization method, a solution polymerization method, a suspension polymerization method, and an emulsion polymerization method.

The first pressure-sensitive adhesive composition may contain any suitable additive within such a range as not to impair the effects of the present invention. As the additive, for example, there are given a tackifier, a cross-linking agent, a cross-linking catalyst, a UV-absorbing agent, a filler, an antioxidant, an antistatic agent, a pigment, a dye, and a silane coupling agent.

### <Second Pressure-Sensitive Adhesive Layer>

As a pressure-sensitive adhesive forming the second pressure-sensitive adhesive layer, any suitable pressure-sensitive adhesive may be employed within such a range as not to impair the effects of the present invention. The pressure-sensitive adhesive forming the second pressure-sensitive adhesive layer is preferably formed of a second pressure-sensitive adhesive composition containing a second base polymer.

From the viewpoint that the effects of the present invention can be further exhibited, the content ratio of the second base polymer in the second pressure-sensitive adhesive composition is preferably from 10 wt % to 100 wt %, more preferably from 20 wt % to 90 wt %, still more preferably from 25 wt % to 85 wt %, particularly preferably from 30 wt % to 80 wt %. When the content ratio of the second base polymer in the second pressure-sensitive adhesive composition falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

From the viewpoint that the effects of the present invention can be further exhibited, the gel fraction of the second adhesive composition is preferably less than 70%, more preferably from 2% to 70%, still more preferably from 2% to 55%, particularly preferably from 1% to 40%. In the first embodiment, the gel fraction of the second adhesive composition is preferred to range from 50% to 70%, still more preferably from 20% to 55%. On the other hand, in the second embodiment, the gel fraction of the second adhesive composition is preferred to range from 1% to %, still more preferably from 1% to 10%, particularly preferably from 1% to 5%. When the gel fraction of the second adhesive composition falls within the above-mentioned range, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-adhesive tape of the present invention and the adherend having a low polar surface can be more easily peeled in an integrated manner from the adherend having a polar surface, and an adhesive residue on the surface of the adherend having a polar surface can be suppressed more.

As the second base polymer, any suitable polymer may be employed within such a range as not to impair the effects of the present invention. Examples of such polymer include an acrylic polymer, an olefin-based polymer, a styrene-based polymer, a urethane-based polymer, and a silicone-based polymer. In addition, examples of such polymer also include an organic solvent-based pressure-sensitive adhesive, an aqueous (water-dispersed) pressure-sensitive adhesive, and a solvent-free (UV-polymerizable/curable or hot-melt) pressure-sensitive adhesive.

When the second base polymer is a second acrylic polymer, the second acrylic polymer preferably contains a monomer unit derived from a (meth)acrylic acid alkyl ester having 2 to 14 carbon atoms in an alkyl group. The alkyl group of the (meth)acrylic acid alkyl ester having 2 to 14 carbon atoms in the alkyl group may be a straight chain or a branched chain. Examples of the (meth)acrylic acid alkyl ester having 2 to 14 carbon atoms in the alkyl group include ethyl (meth)acrylate, n-propyl (meth)acrylate, n-butyl (meth)acrylate, t-butyl (meth) acrylate, 2-ethylhexyl (meth)acrylate, isooctyl (meth)acrylate, and isononyl (meth)acrylate. Of those, n-butyl acrylate and 2-ethylhexyl acrylate are preferred from the viewpoint that the effects of the present invention can be further exhibited.

When the second base polymer is the second acrylic polymer, 50 wt % or more of a monomer unit forming the second acrylic polymer is preferably derived from alkyl (meth) acrylate(s). In the first and second embodiments where the second base polymer is the second acrylic polymer, 50 wt % or more of a monomer unit forming the second acrylic polymer is preferably derived from butyl acrylate. The above-mentioned ratio is preferably from 50 wt % to 99 wt %, more preferably from 55 wt % to 97 wt %, still more preferably from 60 wt % to 95 wt %, particularly preferably from 65 wt % to 95 wt %. When the second acrylic polymer has such composition, when the double-sided pressure-sensitive adhesive tape of the present invention is used for re-peeling an adherend having a low polar surface from an adherend having a polar surface after bonding the adherend having a low polar surface to the adherend having a polar surface, a laminate of the double-sided pressure-sensitive adhesive tape of the present invention and the adherend having a low polar surface can be more easily peeled in an integrated manner from the adherend having a polar surface, and an adhesive residue on the surface of the adherend having a polar surface can be suppressed more.

When the second base polymer is the second acrylic polymer, the second acrylic polymer preferably contains a monomer unit derived from a carboxyl group-containing unsaturated monomer. As the carboxyl group-containing unsaturated monomer, for example, there are given (meth)acrylic acid, itaconic acid, fumaric acid, and maleic acid. Of those, (meth)acrylic acid is preferred from the viewpoint that the effects of the present invention can be further exhibited.

When the second base polymer is the second acrylic polymer, and when the second acrylic polymer contains a monomer unit derived from a (meth)acrylic acid alkyl ester having 2 to 14 carbon atoms in an alkyl group and a monomer unit derived from a carboxyl group-containing unsaturated monomer, from the viewpoint that the effects of the present invention can be further exhibited, the ratio between the monomer unit derived from a (meth)acrylic acid alkyl ester having 2 to 14 carbon atoms in an alkyl group and the monomer unit derived from a carboxyl group-containing unsaturated monomer is as follows. When the content of the monomer unit derived from a (meth)acrylic acid alkyl ester having 2 to 14 carbon atoms in an alkyl group is defined as 100 parts by weight, the content of the monomer unit derived from a carboxyl group-containing unsaturated monomer is preferably from 0.1 part by weight to 10 parts by weight, more preferably from 0.5 part by weight to 8 parts by weight, still more preferably from 1 part by weight to 6 parts by weight, particularly preferably from 1.5 parts by weight to 5 parts by weight.

When the second base polymer is the second acrylic polymer, the second acrylic polymer may contain a monomer unit derived from any other suitable monomer within such a range as not to impair the effects of the present invention. Examples of such other monomer include: hydroxyl group-containing monomers, such as 2-hydroxyethyl (meth)acrylate, 2-hydroxypropyl (meth)acrylate, and hydroxyhexyl (meth)acrylate; nitrogen-containing (meth)acrylates, such as (meth)acrylamide and acryloylmorpholine; methyl (meth)acrylate; alkyl (meth)acrylates each having 15 or more carbon atoms in an alkyl group; vinyl acetate; (meth)acrylonitrile; styrene; vinylidene chloride; and vinyl propionate.

As the weight average molecular weight (Mw) of the second base polymer (in terms of polystyrene) measured by GPC, any suitable weight average molecular weight (Mw) may be employed within such a range as not to impair the effects of the present invention. From the viewpoint that the effects of the present invention can be further exhibited, the weight average molecular weight (Mw) is preferably from 10,000 to 2,000,000, more preferably from 50,000 to 1,900,000, still more preferably from 100,000 to 1,700,000, particularly preferably from 500,000 to 1,500,000.

The second base polymer can be produced by various known methods, and for example, there are given radial polymerization methods, such as a bulk polymerization method, a solution polymerization method, a suspension polymerization method, and an emulsion polymerization method.

The second pressure-sensitive adhesive composition may contain any suitable additive within such a range as not to impair the effects of the present invention. As the additive, for example, there are given a tackifier, a cross-linking agent, a cross-linking catalyst, a UV-absorbing agent, a filler, an antioxidant, an antistatic agent, a pigment, a dye, and a silane coupling agent. Of those additives, in particular, adding a tackifier is one of preferred embodiments from the viewpoint of improving an adhesive property to a surface having a low polarity. As the tackifier, for example, there may be given a rosin-based resin, a terpene-based resin, an aliphatic petroleum resin, an aromatic petroleum resin, a copolymerization petroleum resin, an alicyclic petroleum resin, a xylene resin, and an elastomer. When the tackifier is added to the acrylic polymer, the addition amount of the tackifier is preferably from 1 part by weight to 80 parts by weight, more preferably from 3 parts by weight to 60 parts by weight, still more preferably from 5 parts by weight to 50 parts by weight with respect to 100 parts by weight of the acrylic polymer.

As the cross-linking agent, for example, there may be given a solvent cross-linker within such a range as not to impair the effects of the present invention. As the solvent cross-linker, for example, it can be a suitable amount of aromatic polyisocyanate in an organic solvent, such as ethyl acetate but not limited thereto. From the viewpoint that the effects of the present invention can be further exhibited, the content ratio of the cross-linker in the cross-linking agent is preferably from 30 wt % to 40 wt %.

The second pressure-sensitive adhesive composition may contain any suitable organic solvent within such a range as not to impair the effects of the present invention. As the organic solvent, for example, there are ethyl acetate, toluene, or a combination thereof. Of those, a combination of ethyl acetate and toluene is preferred from the viewpoint that the effects of the present invention can be further exhibited.

From the viewpoint that the effects of the present invention can be further exhibited, the content ratio of the solvent in the second pressure-sensitive adhesive composition is preferably from 50 wt % to 65 wt %. Of those, the content ratio of ethyl acetate in the second pressure-sensitive adhesive composition is preferably from 35 wt % to 45 wt %; and the content ratio of toluene in the second pressure-sensitive adhesive composition is preferably from 15 wt % to 20 wt %.

### <Other Layers>

The double-sided pressure-sensitive adhesive tape of the present invention may include other layers (for example, an intermediate layer and an undercoating layer) within such a range as not to impair the effects of the present invention.

### <Release Liner>

The pressure-sensitive adhesive surfaces of the double-sided pressure-sensitive adhesive tape of the present invention may be protected by a release liner (separator) until the time of use. It should be noted that the pressure-sensitive adhesive surfaces of the double-sided pressure-sensitive adhesive tape may be protected by two release liners, respectively, or may be protected by one release liner having release surfaces as both surfaces in a state of being rolled in a roll shape. The release liner is used as a protective material for the pressure-sensitive adhesive surfaces and peeled off at time of bonding to an adherend. It should be noted that, in the present invention, when a release liner is used, the thickness of the release liner is not included in the total thickness of the double-sided pressure-sensitive adhesive tape.

As the release liner, any suitable release liner may be employed within such a range as not to impair the effects of the present invention. As the release liner, for example, there are given a base material having a release treatment layer, a low adhesive base material formed of a fluorine-based polymer, and a low adhesive base material formed of a non-polar polymer. Examples of the base material having a release treatment layer include a plastic film and paper each having a surface treated with a release agent based on, for example, a silicone, a long chain alkyl, fluorine, or molybdenum sulfide. Examples of the fluorine-based polymer in the low adhesive base material formed of a fluorine-based polymer include polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer. Examples of the non-polar polymer of the low adhesive base material formed of a non-polar polymer include olefin-based resins (for example, polyethylene and polypropylene). It should be noted that the release liner can be formed by known or commonly-used methods. Further, as the thickness of the release liner, any suitable thickness may be employed within such a range as not to impair the effects of the present invention.

### <Manufacturing Method>

The double-sided pressure-sensitive adhesive tape of the present invention may be manufactured by any suitable method within such a range as not to impair the effects of the present invention. As the manufacturing method, for example, there may be given a method involving forming a pressure-sensitive adhesive layer on both surfaces of a base material. For formation of the pressure-sensitive adhesive layer, methods known in the field of a pressure-sensitive adhesive tape may be employed. As a method of forming a pressure-sensitive adhesive layer, for example, there are given a direct transfer method involving applying a pressure-sensitive adhesive composition directly to a base material, followed by drying, and a transfer method involving applying a pressure-sensitive adhesive composition to a release liner, followed by drying, and bonding the resultant to a base material.

As a method of applying a pressure-sensitive adhesive composition, for example, there are given a method involving using an appropriate coater, such as a bar coater, a spin coater, a roll coater, or an applicator, roll coating, gravure coating, reverse coating, roll brush coating, spray coating, and air-knife coating methods, and a method based on extrusion coating using a die coater or the like.

### EXAMPLES

Hereinafter, the present invention is described specifically by way of Examples. However, the present invention is by no means limited to Examples. It should be noted that test and evaluation methods in Examples and the like are as described below. It should be noted that the term “part(s)” in the following description means “part(s) by weight” unless otherwise specified, and the term in the following description means “wt %” unless otherwise specified.

### <Measurement of Weight Average Molecular Weight (Mw)>

The weight average molecular weight (Mw) of a polymer was measured through use of a GPC device (HLC-8220GPC) manufactured by Tosoh Corporation. It should be noted that the weight average molecular weight (Mw) was determined as a value in terms of polystyrene.

Measurement conditions are as follows.
Sample concentration: 0.2 wt % (THF solution)
Sample injecting volume: 10 μl eluting solution
THF flow rate: 0.6 ml/min
Measurement temperature: 40° C.
Sample column: TSK guard column Super HZ-H (single)+TSKgel Super HZM-H (double)
Reference column: TSKgel Super H-RC (single)
Detector: differential refractometer (refractive index (RI) detector)
   <Measurement of Pressure-Sensitive Adhesive Strength of Pressure-Sensitive Adhesive Layer with Respect to SUS304 Steel Plate (Pressure-Sensitive Adhesive Strength with Respect to SUS)>

An obtained double-sided pressure-sensitive adhesive tape was cut to have a width of 20 mm and a length of 80 mm to obtain a sample for evaluation. The surface of a pressure-sensitive adhesive layer of the sample for evaluation was bonded to a SUS304 steel plate by one round movement of a roller of 2.0 kg under an atmosphere at a temperature of 23° C. and a humidity of 50% RH. The resultant was cured for 30 minutes under an atmosphere at a temperature of 23° C. and a humidity of 50% RH. After that, the pressure-sensitive adhesive layer was peeled off at a peel angle of 180° and a rate of pulling of 300 mm/min through use of a universal tensile and compression tester (product name: Tensile and Compression Testing Machine TCM-1kNB, manufactured by Minebea Co., Ltd.) to measure the pressure-sensitive adhesive strength thereof.

<Measurement of Pressure-Sensitive Adhesive Strength of Pressure-Sensitive Adhesive Layer with Respect to Polyethylene (Pressure-Sensitive Adhesive Strength with Respect to PE)>

The obtained double-sided pressure-sensitive adhesive tape was cut to have a width of 20 mm and a length of 80 mm to obtain a sample for evaluation. The surface of a pressure-sensitive adhesive layer of the sample for evaluation was bonded to a polyethylene plate (manufactured by Seika Cooperation, trade name: PE plate) by one round movement of a roller of 2.0 kg under an atmosphere at a temperature of 23° C. and a humidity of 50% RH. The resultant was cured for 30 minutes under an atmosphere at a temperature of 23° C. and a humidity of 50% RH. After that, the pressure-sensitive adhesive layer was peeled off at a peel angle of 180° and a rate of pulling of 300 mm/min through use of a universal tensile and compression tester (product name: Tensile and Compression Testing Machine TCM-1kNB, manufactured by Minebea Co., Ltd.) to measure the pressure-sensitive adhesive strength thereof.

### <Measurement of Elongation Ratio>

An elongation ratio was measured in accordance with the measurement method specified under JIS Z 1523.

The obtained double-sided pressure-sensitive adhesive tape was cut to have a width of 20 mm and a length of 180 mm, and a release liner was removed from to obtain a sample for evaluation.

The sample for evaluation was pulled with a chuck distance of 125 mm at a rate of pulling of 300 mm/min under an atmosphere at a temperature of 23° C. and a humidity of 50% RH through use of a universal tensile and compression tester (product name: Tensile and Compression Testing Machine TCM-1kNB, manufactured by Minebea Co., Ltd.) to read the length at time of fracture. This operation was performed three times, and an average value thereof was defined as an elongation ratio.

Elongation ratio (%)=100×length at time of fracture/chuck distance

### <Measurement of Tensile Strength>

A tensile strength was measured in accordance with the measurement method specified under JIS Z 1523.

The obtained double-sided pressure-sensitive adhesive tape was cut to have a width of 20 mm and a length of 180 mm, and a release liner was removed therefrom to obtain a sample for evaluation.

The sample for evaluation was pulled with a chuck distance of 125 mm at a rate of pulling of 300 mm/min under an atmosphere at a temperature of 23° C. and a humidity of 50% RH through use of a universal tensile and compression tester (product name: Tensile and Compression Testing Machine TCM-1kNB, manufactured by Minebea Co., Ltd.) to read the stress at time of fracture. This operation was performed three times, and an average value thereof was defined as a tensile strength.

### <Measurement of Tear Strength>

Under an atmosphere at a temperature of 23° C. and a humidity of 50% RH, a jig was fixed to one chuck of a universal tensile and compression tester (product name: Tensile and Compression Testing Machine TCM-1kNB, manufactured by Minebea Co., Ltd.). After that, a double-sided pressure-sensitive adhesive tape having a width of 18 mm was inserted into the jig, a loop having a diameter of 50 mm or more was formed so that a pressure-sensitive adhesive layer was placed on an outer side, and an end portion of the loop was fixed to the other chuck. Next, the loop was pulled at a rate of pulling of 300 mm/min, and a value at time when the loop started being torn apart from the end portion was read. This operation was performed three times, and an average value thereof was defined as a tear strength.

### <Measurement of Gel Fraction>

About 0.1 g of an adhesive composition sample (weight: Wg1) was covered with a porous polytetrafluoroethylene film (weight: Wg2) having an average pore diameter of 0.2 μm in a drawstring bag shape, and an opening was tied with a kite string (weight: Wg3). As the porous polytetrafluoroethylene film, a product available under the trade name “Nitoflon (trademark) NTF1122” (manufactured by Nitto Denko Corporation, average pore diameter: 0.2 μm, porosity: 75%, thickness: 85 μm), or an equivalent product thereof was used. The bag was immersed in 50 mL of Ethyl acetate and held at 23° C. for 7 days to elute only a sol component in the adhesive composition sample out of the film. Then, the bag was taken out, and the Ethyl acetate adhering to an outer surface of the bag was removed. Then, the bag was dried at 130° C. for 2 hours, and the weight (Wg4) of the bag was measured. Each value was substituted into the following expression to calculate a gel fraction FG of the adhesive composition sample.

Gel fraction FG(%)=[(Wg4−Wg2−Wg3)/Wg1]×100

<Measurement of Pressure-Sensitive Adhesive Strength of Pressure-Sensitive Adhesive Layer with Respect to Adherend Having Polar Surface>

The pressure-sensitive adhesive strength of a pressure-sensitive adhesive layer with respect to each of a glass plate, a polyvinyl chloride (PVC) plate, a polycarbonate (PC) plate, a polycarbonate (PC)-ABS plate, an ABS plate, and an aluminum (Al) plate was measured. Specifically, the obtained double-sided pressure-sensitive adhesive tape was cut to have a width of 20 mm and a length of 80 mm to obtain a sample for evaluation. The surface of a pressure-sensitive adhesive layer of the sample for evaluation was bonded to each of the above-mentioned various plates by one round movement of a roller of 2.0 kg under an atmosphere at a temperature 23° C. and a humidity of 50% RH. The resultant was cured for 30 minutes under an atmosphere at a temperature of 23° C. and a humidity of 50% RH. Then, the pressure-sensitive adhesive layer was peeled off at a peel angle of 180° and a rate of pulling of 300 mm/min through use of a universal tensile and compression tester (product name: Tensile and Compression Testing Machine TCM-1kNB, manufactured by Minebea Co., Ltd.) to measure the pressure-sensitive adhesive strength thereof.

<Evaluation of Pressure-Sensitive Adhesion Retention of Second Pressure-Sensitive Adhesive Layer with Respect to Adherend Having Low Polar Surface (Evaluation of Pressure-Sensitive Adhesion Retention)>

Specifically, the obtained double-sided pressure-sensitive adhesive tape was cut to have a width of 20 mm and a length of 100 mm to obtain a sample for evaluation. The first surface of a pressure-sensitive adhesive layer of the sample for evaluation was bonded to Al plate (thickness 0.3 mm) by one round movement of a roller of 2.0 kg under an atmosphere at a temperature of 23° C. and a humidity of 50% RH. Then second surface of a pressure-sensitive adhesive sample was bonded to PE sheet (10 μm) by hand with enough pressure. The resultant was cured for 30 minutes under an atmosphere at a temperature of 23° C. and a humidity of 50% RH. Then, the pressure-sensitive adhesive layer was peeled off by hand at angle of 140° and the appearance of the adherend surface was judged.

The evaluation was carried out based on the following criteria.
∘: An adherend having a low polar surface can be easily peeled off in an integrated manner with the double-sided pressure-sensitive adhesive tape.
×: An adherend having a low polar surface is peeled from a double-sided pressure-sensitive adhesive tape
   <Evaluation Regarding Whether or Not Laminate of Double-Sided Pressure-Sensitive Adhesive Tape and Adherend Having Low Polar Surface can be Peeled in Integrated Manner from Adherend Having Polar Surface (Evaluation of Integrated Peeling)>

The double-sided pressure-sensitive adhesive tape was cut to have a width of 20 mm and a length of 100 mm to obtain a sample for evaluation. The first surface of a pressure-sensitive adhesive layer of the sample for evaluation was bonded to Al plate (thickness 0.3 mm) by one round movement of a roller of 2.0 kg under an atmosphere at a temperature of 23° C. and a humidity of 50% RH. Then second surface of a pressure-sensitive adhesive sample was bonded to PE sheet (10 μm) by hand with enough pressure. The Al plate laminated with sample was painted with solvent or water based paint and dried for 2 hours under an atmosphere at a temperature of 23° C. and a humidity of 50% RH. Then the tape sample was peeled off by hand and the appearance of the adherend surface was judged.

The evaluation was carried out based on the following criteria.
⊚: A laminate of a double-sided pressure-sensitive adhesive tape and an adherend having a low polar surface can be easily peeled off in an integrated manner with the double-sided pressure-sensitive adhesive tape, and an adhesive residue does not remain on the surface of an adherend having a polar surface.
∘: A laminate of a double-sided pressure-sensitive adhesive tape and an adherend having a low polar surface can be peeled off in an integrated manner and an adhesive residue does not remain on the surface of an adherend having a polar surface, but peeling is not easy.
×: A base material is torn apart.
Δ: An adherend having a low polar surface is peeled from the double-sided pressure-sensitive adhesive tape.

### Production Example 1

### (Production of Pressure-Sensitive Adhesive Composition (A))

A monomer component containing 92 parts of 2-ethylhexyl acrylate (2EHA), 5 parts of n-butyl acrylate (BA), 2 parts of methyl methacrylate (MMA), and 1 part of acrylic acid (AA), 2 parts of an emulsifier in terms of solid content with respect to 100 parts of the monomer component, and 100 parts of ion-exchanged water were mixed and emulsified to prepare an aqueous emulsion of a monomer mixture (monomer emulsion). Sodium lauryl sulfate was used as the emulsifier.

The monomer emulsion was loaded into a reaction vessel provided with a cooling tube, a nitrogen introducing tube, a thermometer, and a stirring device and stirred at room temperature for 1 hour or more while nitrogen gas was introduced. Then, the system was increased in temperature to 60° C. 0.1 Part of 2,2′-azobis[N-(2-carboxyethyl)-2-methylpropionamidine]hydrate (polymerization initiator) (trade name: “VA-057”, manufactured by Wako Pure Chemical Industries, Ltd.) was loaded into the reaction vessel, and the monomer emulsion was allowed to react for 6 hours while the system was kept at 60° C. After the system was cooled to normal temperature, the pH was adjusted to 7.5 by adding 10% ammonium water to the system to obtain an aqueous dispersion liquid of an acrylic polymer.

An epoxy-based cross-linking agent was added to and mixed with the aqueous dispersion liquid in an amount of 0.08 part with respect to 100 parts of the solid content of the acrylic polymer contained in the aqueous dispersion liquid. As the epoxy-based cross-linking agent, “E10-C” (trade name, manufactured by Soken Chemical & Engineering Co., Ltd.) was used.

Thus, a pressure-sensitive adhesive composition (A) was prepared.

The weight average molecular weight (Mw) of a pressure-sensitive adhesive forming the pressure-sensitive adhesive composition (A) was 80,000, and the gel fraction thereof was 82%.

### Production Example 2

### (Production of Pressure-Sensitive Adhesive Composition (B))

A monomer component containing 30 parts of 2-ethylhexyl acrylate (2EHA), 70 parts of n-butyl acrylate (BA), 3 parts of acrylic acid (AA), and 0.03 part of 3-methacryloyloxypropyltrimethoxysilane (trade name: “KBM-503”, manufactured by Shin-Etsu Silicone), 2 parts of an emulsifier in terms of solid content with respect to 100 parts of the monomer component, and 100 parts of ion-exchanged water were mixed and emulsified to prepare an aqueous emulsion of a monomer mixture (monomer emulsion). Sodium lauryl sulfate was used as the emulsifier.

The monomer emulsion was loaded into a reaction vessel provided with a cooling tube, a nitrogen introducing tube, a thermometer, and a stirring device and stirred at room temperature for 1 hour or more while nitrogen gas was introduced. Then, the system was increased in temperature to 60° C. 0.1 Part of 2,2′-azobis[N-(2-carboxyethyl)-2-methylpropionamidine]hydrate (polymerization initiator) (trade name: “VA-057”, manufactured by Wako Pure Chemical Industries, Ltd.) was loaded into the reaction vessel, and the monomer emulsion was allowed to react for 6 hours while the system was kept at 60° C. After the system was cooled to normal temperature, the pH was adjusted to 7.5 by adding 10% ammonium water to the system to obtain an aqueous dispersion liquid of an acrylic polymer. As a tackifier resin, 30 parts by weight (with respect to 100 parts by weight (solid content) of the acrylic polymer) of an aqueous emulsion of a terpene phenol-based resin (trade name: “Tamanol E-200NT”, manufactured by Arakawa Chemical Industries, Ltd.) was added to the aqueous dispersion liquid.

Thus, a pressure-sensitive adhesive composition (B) was prepared.

The weight average molecular weight (Mw) of a pressure-sensitive adhesive forming the pressure-sensitive adhesive composition (B) was 80,000, and the gel fraction thereof was 27%.

### Example 1

Example 1 represents the first embodiment of the present invention.

As a base material, rubber emulsion (trade name: TRMG-40N″, manufactured by Thai Regitex Co., Ltd) was applied as an undercoating agent (primer) to a first surface of Japanese paper having a basis weight of 43 g/m² and a thickness of 73 μm and dried at 130° C. for 2 minutes to form an undercoating layer having a basis weight of 3 g/m².

Then, the pressure-sensitive adhesive composition (A) obtained in Production Example 1 was applied to the first surface and dried at 100° C. for 2 minutes to form a pressure-sensitive adhesive layer (A1) having a thickness of 25 μm. A light release surface side of a release liner (trade name: 110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (A1).

Then, the pressure-sensitive adhesive composition (B) obtained in Production Example 2 was applied to a second surface of the base material and dried at 100° C. for 2 minutes to form a pressure-sensitive adhesive layer (B1) having a thickness of 40 μm. A heavy release surface side of a release liner (trade name: 110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (B1).

Thus, a double-sided first pressure-sensitive adhesive tape having a configuration of [release liner]/[pressure-sensitive adhesive layer (A1) serving as first pressure-sensitive adhesive layer]/[base material of Japanese paper]/[pressure-sensitive adhesive layer (B1) serving as second pressure-sensitive adhesive layer]/[release liner] was obtained.

The results are shown in Table 1 and Table 2.

### Comparative Example 1

The pressure-sensitive adhesive composition (A) obtained in Production Example 1 was applied to the light release surface side of the same release liner as that of Example 1 and dried at 100° C. for 2 minutes to form a pressure-sensitive adhesive layer (A1) having a thickness of 25 μm. Then, nonwoven fabric having a basis weight of 14 g/m² and a thickness of 43 μm was bonded as a base material to a pressure-sensitive adhesive surface of the formed pressure-sensitive adhesive layer (A1) (I).

Then, another release liner of the same kind as that of Example 1 was prepared. The pressure-sensitive adhesive composition (B) obtained in Production Example 2 was applied to a heavy release surface side of the release liner and dried at 100° C. for 2 minutes to form a pressure-sensitive adhesive layer (B1) having a thickness of 40 μm. The pressure-sensitive adhesive surface of the formed pressure-sensitive adhesive layer (B1) was bonded to a surface of the above-mentioned (I) on which the nonwoven fabric was exposed.

Thus, a double-sided pressure-sensitive adhesive tape (C1) having a configuration of [release liner]/[pressure-sensitive adhesive layer (A1) serving as first pressure-sensitive adhesive layer]/[nonwoven fabric]/[pressure-sensitive adhesive layer (B1) serving as second pressure-sensitive adhesive layer]/[release liner] was obtained.

The results are shown in Table 1 and Table 2.

### Comparative Example 2

As a base material, rubber emulsion (trade name: TRMG-40N″, manufactured by Thai Regitex Co. Ltd) was applied as an undercoating agent (primer) to a first surface of Japanese paper having a basis weight of 43 g/m² and a thickness of 73 μm and dried at 130° C. for 2 minutes to form an undercoating layer having a basis weight of 3 g/m².

Then, the pressure-sensitive adhesive composition (B) obtained in Production Example 2 was applied to the first surface and dried at 100° C. for 2 minutes to form a pressure-sensitive adhesive layer (B2) having a thickness of 25 μm. A light release surface side of a release liner (trade name: 110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (B2).

Then, the pressure-sensitive adhesive composition (B) obtained in Production Example 2 was applied to a second surface of the base material and dried at 100° C. for 2 minutes to form a pressure-sensitive adhesive layer (B1) having a thickness of 40 μm. A heavy release surface side of a release liner (trade name: “110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (B1).

Thus, a double-sided pressure-sensitive adhesive tape (C2) having a configuration of [release liner]/[pressure-sensitive adhesive layer (B2) serving as first pressure-sensitive adhesive layer]/[base material of Japanese paper]/[pressure-sensitive adhesive layer (B1) serving as second pressure-sensitive adhesive layer]/[release liner] was obtained.

The results are shown in Table 1 and Table 2.

### Comparative Example 3

The pressure-sensitive adhesive composition (B) obtained in Production Example 2 was applied to the light release surface side of the same release liner as that of Example 1 and dried at 100° C. for 2 minutes to form a pressure-sensitive adhesive layer (B2) having a thickness of 25 μm. Then, nonwoven fabric having a basis weight of 14 g/m² and a thickness of 43 μm was bonded as a base material to a pressure-sensitive adhesive surface of the formed pressure-sensitive adhesive layer (B2) (I).

Then, another release liner of the same kind as that of Example 1 was prepared. The pressure-sensitive adhesive composition (B) obtained in Production Example 2 was applied to a heavy release surface side of the release liner and dried at 100° C. for 2 minutes to form a pressure-sensitive adhesive layer (B1) having a thickness of 40 μm. The pressure-sensitive adhesive surface of the formed pressure-sensitive adhesive layer (B1) was bonded to a surface of the above-mentioned (I) on which the nonwoven fabric was exposed.

Thus, a double-sided pressure-sensitive adhesive tape (C3) having a configuration of [release liner]/[pressure-sensitive adhesive layer (B2) serving as first pressure-sensitive adhesive layer]/[nonwoven fabric]/[pressure-sensitive adhesive layer (B1) serving as second pressure-sensitive adhesive layer]/[release liner] was obtained.

The results are shown in Table 1 and Table 2.

### Comparative Example 4

As a base material, rubber emulsion (trade name: “TRMG-40N”, manufactured by Thai Regitex Co. Ltd) was applied as an undercoating agent (primer) to a first surface of Japanese paper having a basis weight of 43 g/m² and a thickness of 73 μm and dried at 130° C. for 2 minutes to form an undercoating layer having a basis weight of 3 g/m².

Then, the pressure-sensitive adhesive composition (A) obtained in Production Example 1 was applied to the first surface and dried at 100° C. for 2 minutes to form a pressure-sensitive adhesive layer (A1) having a thickness of 25 μm. A light release surface side of a release liner (trade name: “110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (A1).

Then, the pressure-sensitive adhesive composition (A) obtained in Production Example 1 was applied to a second surface of the base material and dried at 100° C. for 2 minutes to form a pressure-sensitive adhesive layer (A2) having a thickness of 40 μm. A heavy release surface side of a release liner (trade name: “110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (A2).

Thus, a double-sided pressure-sensitive adhesive tape (C4) having a configuration of [release liner]/[pressure-sensitive adhesive layer (A1) serving as first pressure-sensitive adhesive layer]/[base material of Japanese paper]/[pressure-sensitive adhesive layer (A2) serving as second pressure-sensitive adhesive layer]/[release liner] was obtained.

The results are shown in Table 1 and Table 2.

### Comparative Example 5

The pressure-sensitive adhesive composition (A) obtained in Production Example 1 was applied to the light release surface side of the same release liner as that of Example 1 and dried at 100° C. for 2 minutes to form a pressure-sensitive adhesive layer (A1) having a thickness of 25 μm. Then, nonwoven fabric having a basis weight of 14 g/m² and a thickness of 43 μm was bonded as a base material to a pressure-sensitive adhesive surface of the formed pressure-sensitive adhesive layer (A1) (I).

Then, another release liner of the same kind as that of Example 1 was prepared. The pressure-sensitive adhesive composition (A) obtained in Production Example 1 was applied to a heavy release surface side of the release liner and dried at 100° C. for 2 minutes to form a pressure-sensitive adhesive layer (A2) having a thickness of 40 μm. The pressure-sensitive adhesive surface of the formed pressure-sensitive adhesive layer (A2) was bonded to a surface of the above-mentioned (I) on which the nonwoven fabric was exposed.

Thus, a double-sided pressure-sensitive adhesive tape (C1) having a configuration of [release liner]/[pressure-sensitive adhesive layer (A1) serving as first pressure-sensitive adhesive layer]/[nonwoven fabric]/[pressure-sensitive adhesive layer (A2) serving as second pressure-sensitive adhesive layer]/[release liner] was obtained.

The results are shown in Table 1 and Table 2.

### Production Example 3

### (Production of Pressure-Sensitive Adhesive Composition (X))

38 parts of alkyl (meth)acrylate(s), 2 parts of rosin ester, 45 parts of ethyl acetate and 15 parts of toluene were mixed to obtain a liquid mixture. On the other hand, 30 parts of aromatic polyisocyanate and 70 parts of ethyl acetate were mixed to obtain a solvent crosslinker mixture. The liquid mixture and the crosslinker mixture were mixed in a ratio of 100 phr to 2.5 phr in a tank mixer under stirring at room temperature for 2 hours or more until homogenize.

Thus, a pressure-sensitive adhesive composition (X) was prepared.

The weight average molecular weight (Mw) of a pressure-sensitive adhesive forming the pressure-sensitive adhesive composition (B) was 970,000, and the gel fraction thereof was 3.3%.

### Example 2

Example 2 represents the second embodiment of the present invention.

As a base material, rubber emulsion (trade name: TRMG-40N″, manufactured by Thai Regitex Co., Ltd) was applied as an undercoating agent (primer) to a first surface of Japanese paper having a basis weight of 43 g/m² and a thickness of 73 μm and dried at 130° C. for 2 minutes to form an undercoating layer having a basis weight of 3 g/m².

Then, the pressure-sensitive adhesive composition (A) obtained in Production Example 1 was applied to the first surface and dried at 100° C. for 2 minutes to form a pressure-sensitive adhesive layer (A1) having a thickness of 25 μm. A light release surface side of a release liner (trade name: 110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (A1).

Then, the pressure-sensitive adhesive composition (X) obtained in Production Example 3 was applied to a second surface of the base material and dried at 100° C. for 2 minutes to form a pressure-sensitive adhesive layer (X1) having a thickness of 40 μm. A heavy release surface side of a release liner (trade name: 110 gsm without printing 8B+8B”, manufactured by Pao Yan Tsae Co. Ltd) having both surfaces treated with a Si-based release agent was bonded to a pressure-sensitive adhesive surface of the formed pressure-sensitive adhesive layer (X1).

Thus, a double-sided second pressure-sensitive adhesive tape having a configuration of [release liner]/[pressure-sensitive adhesive layer (A1) serving as first pressure-sensitive adhesive layer]/[base material of Japanese paper]/[pressure-sensitive adhesive layer (X1) serving as second pressure-sensitive adhesive layer]/[release liner] was obtained.

The results are shown in Table 1 and Table 2.

TABLE 1

| | | | | | Comparative | | Comparative | | Comparative | | Comparative | | Comparative | |
|---|---|---|---|---|---|---|---|---|---|---|---|---|---|---|
| | Example 1 | | Example 2 | | Example 1 (C1) | | Example 2 (C2) | | Example 3 (C3) | | Example 4 (C4) | | Example 5 (C5) | |
| | Pressure-sensitive adhesive layer | | | | | | | | | | | | | |
| | First | Second | First | Second | First | Second | First | Second | First | Second | First | Second | First | Second |
| | (1) | (2) | (1) | (2) | (1) | (2) | (2) | (2) | (2) | (2) | (1) | (1) | (1) | (1) |
| Thickness of | 25 μm | 40 μm | 25 μm | 40 μm | 25 μm | 40 μm | 25 μm | 40 μm | 25 μm | 40 μm | 25 μm | 40 μm | 25 μm | 40 μm |
| pressure- | | | | | | | | | | | | | | |
| sensitive | | | | | | | | | | | | | | |
| adhesive | | | | | | | | | | | | | | |
| layer | | | | | | | | | | | | | | |
| Base material | Japanese paper | | Japanese paper | | Nonwoven fabric | | Japanese paper | | Nonwoven fabric | | Japanese paper | | Nonwoven fabric | |
| Thickness of | 73 μm | | 73 μm | | 43 μm | | 73 μm | | 43 μm | | 73 μm | | 43 μm | |
| base material | | | | | | | | | | | | | | |
| Pressure- | 2.42 | 7.66 | 2.42 | 10.9 | 4.03 | 15.59 | 10.24 | 12.45 | 11.77 | 15.13 | 2.25 | 3.51 | 2.56 | 3.96 |
| sensitive | | | | | | | | | | | | | | |
| adhesive | | | | | | | | | | | | | | |
| strength A | | | | | | | | | | | | | | |
| with respect | | | | | | | | | | | | | | |
| to SUS | | | | | | | | | | | | | | |
| (N/20 mm) | | | | | | | | | | | | | | |
| Difference of | 5.24 | | 8.48 | | 11.56 | | 2.21 | | 3.36 | | 1.26 | | 1.40 | |
| A | | | | | | | | | | | | | | |
| (N/20 mm) | | | | | | | | | | | | | | |
| Pressure- | 1.54 | 5.6 | 1.54 | 7.64 | 2.25 | 8.25 | 6.85 | 6.0 | 7.37 | 8.30 | 1.67 | 3.02 | 2.22 | 3.43 |
| sensitive | | | | | | | | | | | | | | |
| adhesive | | | | | | | | | | | | | | |
| strength with | | | | | | | | | | | | | | |
| respect to PE | | | | | | | | | | | | | | |
| (N/20 mm) | | | | | | | | | | | | | | |

| | | | | | | | |
|---|---|---|---|---|---|---|---|
| Elongation | 16.94 | 11.82 | 5.00 | 13.99 | 7.2 | 14.16 | 4.2 |
| ratio | | | | | | | |
| (%) | | | | | | | |
| Tensile | 71.85 | 115.14 | 5.32 | 73.85 | 9.08 | 74.73 | 5.05 |
| strength | | | | | | | |
| (N/20 mm) | | | | | | | |
| Tear strength | 61.33 | 89.09 | 38.74 | 67.73 | 38.21 | 68.75 | 33.51 |
| (N/20 mm) | | | | | | | |

TABLE 2

| | | | | | Comparative | | Comparative | | Comparative | | Comparative | | Comparative | |
|---|---|---|---|---|---|---|---|---|---|---|---|---|---|---|
| | Example 1 | | Example 2 | | Example 1 (C1) | | Example 2 (C2) | | Example 3 (C3) | | Example 4 (C4) | | Example 5 (C5) | |
| Pressure-sensitive | 1.17 | 8.94 | 1.17 | 10.91 | 1.97 | 9.36 | 9.04 | 10.01 | 9.48 | 11.11 | 1.31 | 1.74 | 1.86 | 3 |
| adhesive strength | N/20 | N/20 | N/20 | N/20 | N/20 | N/20 | N/20 | N/20 | N/20 | N/20 | N/20 | N/20 | N/20 | N/20 |
| with respect to | mm | mm | mm | mm | mm | mm | mm | mm | mm | mm | mm | mm | mm | mm |
| glass | | | | | | | | | | | | | | |
| Pressure-sensitive | 5.51 | 8.35 | 5.51 | 17.62 | 6.45 | 17.73 | 21.16 | 27.46 | 18.09 | 24.51 | 5.65 | 7.04 | 6.73 | 4.8 |
| adhesive strength | N/20 | N/20 | N/20 | N/20 | N/20 | N/20 | N/20 | N/20 | N/20 | N/20 | N/20 | N/20 | N/20 | N/20 |
| with respect to PVC | mm | mm | mm | mm | mm | mm* | mm* | mm* | mm* | mm* | mm | mm | mm | mm |
| Pressure-sensitive | 3.80 | 8.80 | 3.80 | 12.04 | 5.38 | 11.1 | 16.18 | 20.19 | 12.24 | 16.69 | 3.58 | 4.86 | 4.03 | 3.63 |
| adhesive strength | N/20 | N/20 | N/20 | N/20 | N/20 | N/20 | N/20 | N/20 | N/20 | N/20 | N/20 | N/20 | N/20 | N/20 |
| with respect to PC | mm | mm | mm | mm | mm | mm* | mm | mm | mm* | mm* | mm | mm | mm | mm |
| Pressure-sensitive | 3.94 | 9.71 | 3.94 | 11.95 | 4.7 | 10.05 | 15.72 | 20.81 | 11.26 | 16.17 | 4.36 | 5.63 | 4.6 | 4.09 |
| adhesive strength | N/20 | N/20 | N/20 | N/20 | N/20 | N/20 | N/20 | N/20 | N/20 | N/20 | N/20 | N/20 | N/20 | N/20 |
| with respect to PC- | mm | mm | mm | mm | mm | mm | mm | mm | mm | mm | mm | mm | mm | mm |
| ABS | | | | | | | | | | | | | | |
| Pressure-sensitive | 2.10 | 10.96 | 2.10 | 9.18 | 2.6 | 5.17 | 9.93 | 12 | 6.87 | 9.53 | 2.2 | 2.52 | 2.2 | 2.87 |
| adhesive strength | N/20 | N/20 | N/20 | N/20 | N/20 | N/20 | N/20 | N/20 | N/20 | N/20 | N/20 | N/20 | N/20 | N/20 |
| with respect to ABS | mm | mm | mm | mm | mm | mm | mm | mm | mm | mm | mm | mm | mm | mm |
| Pressure-sensitive | 2.11 | 11.07 | 2.11 | 9.26 | 2.40 | 9.28 | 14.98 | 18.61 | 11.43 | 14.31 | 1.55 | 2.29 | 1.41 | 2.37 |
| adhesive strength | N/20 | N/20 | N/20 | N/20 | N/20 | N/20 | N/20 | N/20 | N/20 | N/20 | N/20 | N/20 | N/20 | N/20 |
| with respect to Al | mm | mm | mm | mm | mm | mm | mm | mm | mm | mm | mm | mm | mm | mm |

| | | | | | | | |
|---|---|---|---|---|---|---|---|
| Evaluation of | ◯ | ◯ | ◯ | ◯ | ◯ | X | X |
| pressure-sensitive | | | | | | | |
| adhesion retention | | | | | | | |
| Evaluation of | ⊚ | ⊚ | X | ◯ | X | Δ | Δ |
| integrated peeling | | | | | | | |

*An adhesive residue was observed

### INDUSTRIAL APPLICABILITY

The double-sided pressure-sensitive adhesive tape of the present invention is suitable particularly for applications such as (temporarily) fixing wood pieces in DIY, (temporary) fixing, which is used for positioning and stacking stone materials such as blocks, fixing a residential moisture-permeable waterproof sheet.

### DESCRIPTION OF SYMBOLS

10 first pressure-sensitive adhesive layer
20 second pressure-sensitive adhesive layer
30 base material
40 release liner
100 double-sided pressure-sensitive adhesive tape

1. A double-sided pressure-sensitive adhesive tape, comprising
a first pressure-sensitive adhesive layer, a base material, and a second pressure-sensitive adhesive layer in the stated order,
wherein the second pressure-sensitive adhesive layer has a pressure-sensitive adhesive strength with respect to a SUS304 steel plate, which is larger than a pressure-sensitive adhesive strength of the first pressure-sensitive adhesive layer with respect to the SUS304 steel plate,
wherein the pressure-sensitive adhesive strength of the first pressure-sensitive adhesive layer with respect to the SUS304 steel plate is from 0.5 N/20 mm to 5 N/20 mm, and
wherein the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate have a difference of from 3 N/20 mm to 20 N/20 mm.

2. The double-sided pressure-sensitive adhesive tape according to claim 1, wherein the pressure-sensitive adhesive strength of the second pressure-sensitive adhesive layer with respect to the SUS304 steel plate and the pressure-sensitive adhesive strength of the first pressure-sensitive adhesive layer with respect to the SUS304 steel plate have a difference of from 4 N/20 mm to 20 N/20 mm.

3. The double-sided pressure-sensitive adhesive tape according to claim 1, wherein the second pressure-sensitive adhesive layer has a pressure-sensitive adhesive strength with respect to polyethylene of from 3 N/20 mm to 15 N/20 mm.

4. The double-sided pressure-sensitive adhesive tape according to claim 1, wherein the double-sided pressure-sensitive adhesive tape has an elongation ratio of 2% or more.

5. The double-sided pressure-sensitive adhesive tape according to claim 1, wherein the double-sided pressure-sensitive adhesive tape has a tensile strength of 20 N/20 mm or more.

6. The double-sided pressure-sensitive adhesive tape according to claim 1, wherein the double-sided pressure-sensitive adhesive tape has a tear strength of 40 N/20 mm or more.

7. The double-sided pressure-sensitive adhesive tape according to claim 1, wherein the base material comprises a paper material.

8. The double-sided pressure-sensitive adhesive tape according to claim 1, wherein the first pressure-sensitive adhesive layer is formed of a first pressure-sensitive adhesive composition containing a first base polymer.

9. The double-sided pressure-sensitive adhesive tape according to claim 8, wherein the first adhesive composition has a gel fraction of 50% or more.

10. The double-sided pressure-sensitive adhesive tape according to claim 8, wherein the first base polymer comprises a first acrylic polymer.

11. The double-sided pressure-sensitive adhesive tape according to claim 10, wherein the first acrylic polymer contains a monomer unit, 70 wt % or more of the monomer unit being derived from 2-ethylhexyl acrylate.

12. The double-sided pressure-sensitive adhesive tape according to claim 1, wherein the second pressure-sensitive adhesive layer is formed of a second pressure-sensitive adhesive composition containing a second base polymer.

13. The double-sided pressure-sensitive adhesive tape according to claim 12, wherein the second adhesive composition has a gel fraction of less than 70%.

14. The double-sided pressure-sensitive adhesive tape according to claim 12, wherein the second base polymer comprises a second acrylic polymer.

15. The double-sided pressure-sensitive adhesive tape according to claim 14, wherein the second acrylic polymer contains a monomer unit, 50 wt % or more of the monomer unit being derived from alkyl (meth)acrylate.

16. The double-sided pressure-sensitive adhesive tape according to claim 1, wherein the base material has a thickness of from 10 μm to 100 μm.

17. The double-sided pressure-sensitive adhesive tape according to claim 16, wherein the thickness of the base material is from 30 μm to 100 μm.

18. The double-sided pressure-sensitive adhesive tape according to claim 1, wherein the first pressure-sensitive adhesive layer has a thickness of from 5 μm to 50 μm.

19. The double-sided pressure-sensitive adhesive tape according to claim 18, wherein the thickness of the first pressure-sensitive adhesive layer is from 10 μm to 40 μm.

20. The double-sided pressure-sensitive adhesive tape according to claim 1, wherein the second pressure-sensitive adhesive layer has a thickness of from 10 μm to 100 μm.

21. The double-sided pressure-sensitive adhesive tape according to claim 20, wherein the thickness of the second pressure-sensitive adhesive layer is from 20 μm to 60 μm.
